(19) United States
(12) Patent Application Publication
(10) Pub. No.: US 2012/0313748 A1
(43) Pub. Date: Dec. 13, 2012

(54) AUTHENTICATION OF A SECURITY MARKER

(76) Inventors: Thomas D. Pawlik, Rochester, NY (US); Myra T. Olm, Webster, NY (US); Mark P. Henry, Rush, NY (US)

(21) Appl. No.: 13/156,620

(22) Filed: Jun. 9, 2011

(51) Int. Cl. G05B 19/00

(52) U.S. Cl. 340/5.8

(57) ABSTRACT

A method for authenticating security markers includes illuminating the security marker with a laser, detecting an optical response from the security marker, changing a temperature of the laser to vary the wavelength of radiation produced by the laser; detecting changes in the optical response from the security marker as the wavelength of the radiation changes, comparing the optical response profile from the security marker as it varies with changes in wavelength to a reference profile; and authenticating the security marker if the optical response profile matches the reference profile.

### CROSS REFERENCE TO RELATED APPLICATIONS

Reference is made to commonly-assigned copending U.S. patent application Ser. No. ______ (Attorney Docket No. K000242US01NAB), filed herewith, entitled METHOD FOR AUTHENTICATING SECURITY MARKERS, by Pawlik et al.; and U.S. patent application Ser. No. ______ (Attorney Docket No. K000387US01NAB), filed herewith, entitled AUTHENTICATION OF A SECURITY MARKER, by Pawlik et al.; the disclosures of which are incorporated herein.

### FIELD OF THE INVENTION

The present invention relates in general to authenticating objects and in particular to using the temperature dependence of the wavelength of lasers as a means to identify an authentic object.

### BACKGROUND OF THE INVENTION

Many high value products are subject to counterfeiting and there is a need to authenticate objects to differentiate the objects from counterfeits. One method of authenticating objects incorporates an optically active compound in a marker on the object. The marker is illuminated and the luminescence from the optically active compounds is detected. Subject to certain algorithms the marker is either authenticated or rejected. Optically active compounds with narrow excitation bands are often preferred because they have distinct optical properties. However, when illuminated with a light source with a wide bandwidth, such as a LED, they often cannot be distinguished from one another. Even if a narrow bandwidth illumination source with fixed wavelength were available, the optical response would only be determined at one wavelength and it would for example be ambiguous whether the optical response was low in luminescence intensity because the level of the optically active compound was low or the wavelength of illumination was mismatched with the wavelength of the excitation band. Therefore, a tunable narrow illumination source would be useful in order to identify specific optically active compounds. One can obtain a narrower bandwidth of illumination by using a wavelength-dispersive element such as a grating, filter or prism in the pathway of the illuminating light. However, these components increase the space requirements for the detection system and decrease the sensitivity of detection.

### SUMMARY OF THE INVENTION

Briefly, according to one aspect of the present invention a method for authenticating security markers includes illuminating the security marker with a laser, detecting an optical response from the security marker, changing a temperature of the laser to vary the wavelength of radiation produced by the laser; detecting changes in the optical response from the security marker as the wavelength of the radiation changes, comparing the optical response profile from the security marker as it varies with changes in wavelength to a reference profile; and authenticating the security marker if the optical response profile matches the reference profile.

The invention and its objects and advantages will become more apparent in the detailed description of the preferred embodiment presented below.

### BRIEF DESCRIPTION OF THE DRAWINGS

FIG. 1 shows a plan view of a security marker detection system;

FIG. 2 shows a block diagram of a security marker detection system;

FIG. 3 shows the excitation and emission spectra of two markers;

FIG. 4 shows the temperature profile of the security marker detection system for several markers;

FIG. 5 shows the temperature profile of the security marker detection system for several markers where certain data points have been highlighted; and

FIG. 6 shows a table of response values extracted from FIG. 5 and compares them to response values of an unknown marker.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

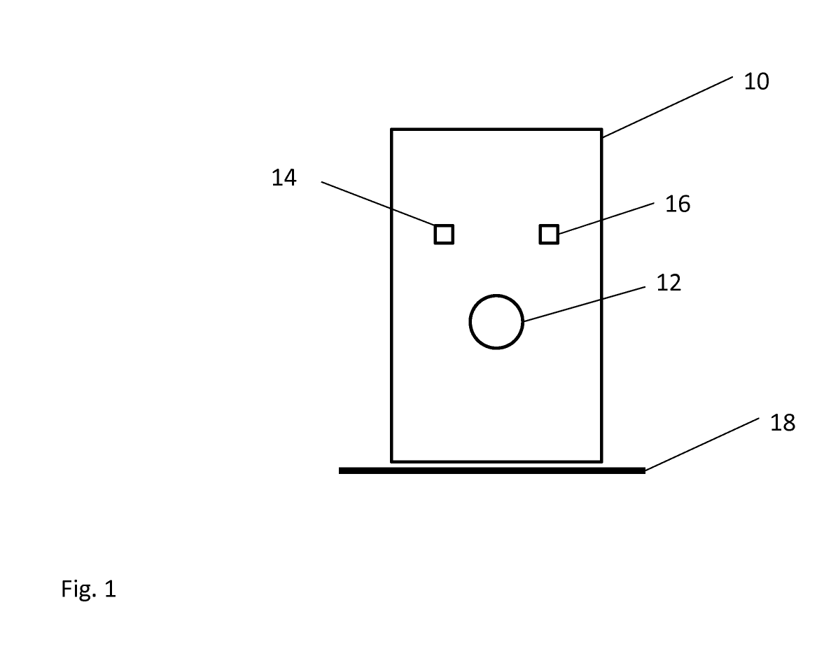

Referring now to FIG. 1, which shows a security marker detection system 10 which can be used to detect emission of security marker materials. FIG. 1 also shows the item to be authenticated 18. Authentication is performed by pressing the test button 12. The result is displayed by either a pass indicator light 14 or a fail indicator light 16.

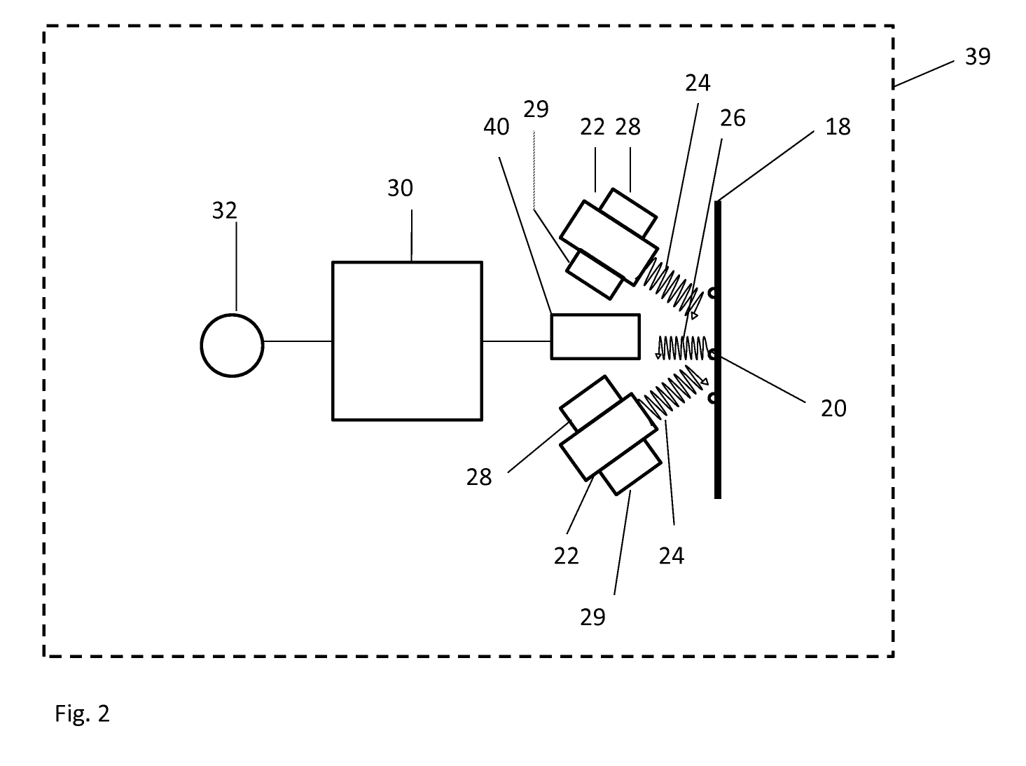

Referring now to FIG. 2 which shows a security marker detection system 39 which can be used to detect emission of security marker materials in a non image-wise fashion. One or more irradiation sources 22 direct electromagnetic radiation towards the item to be authenticated 18. The authentic item contains a random distribution of marker particles 20 either in an ink or in an overcoat varnish. The marker particles emit electromagnetic radiation 26 as a response to the radiation from the irradiation sources 22 which is detected by a photodetector 40. A microprocessor 30 analyzes the photodetector signal and determines a pass or fail indication which is displayed on the authentication indicator 32. Pass or fail indication can, for example, represent authentic and non-authentic, respectively. The irradiation sources 22 are thermally coupled to a temperature sensor 28 and heating/cooling element 29, which are also controlled by the microprocessor 30. The intensity of the emitted light from each individual marker depends in the illumination intensity and the overlap between the spectral band of the illuminating radiation and the spectral shape of the excitation band of the marker. If a semiconductor laser is used as an excitation source, the illumination has a narrow bandshape, but the wavelength of illumination varies with the temperature of the laser. The emission wavelength will shift to longer wavelength with increasing temperature and to shorter wavelengths with decreasing temperature. Typical shifts are 0.3 nm/° C. For security markers with a narrow excitation band, the response of the security marker detection system will vary with the temperature of the illumination source. The invention makes use of this effect by collecting the marker response for a plurality of laser temperatures that correspond to different excitation wavelengths.

This measurement is initiated by pressing the test button 12. The laser temperature is changed by the heating/cooling element 29 and measured by the temperature sensor. After the measurement has ended, the marker response at the various temperatures is compared to stored marker responses for a variety of possible markers. A pass/fail decision is based on a whether the measured response matches the intended marker profile.

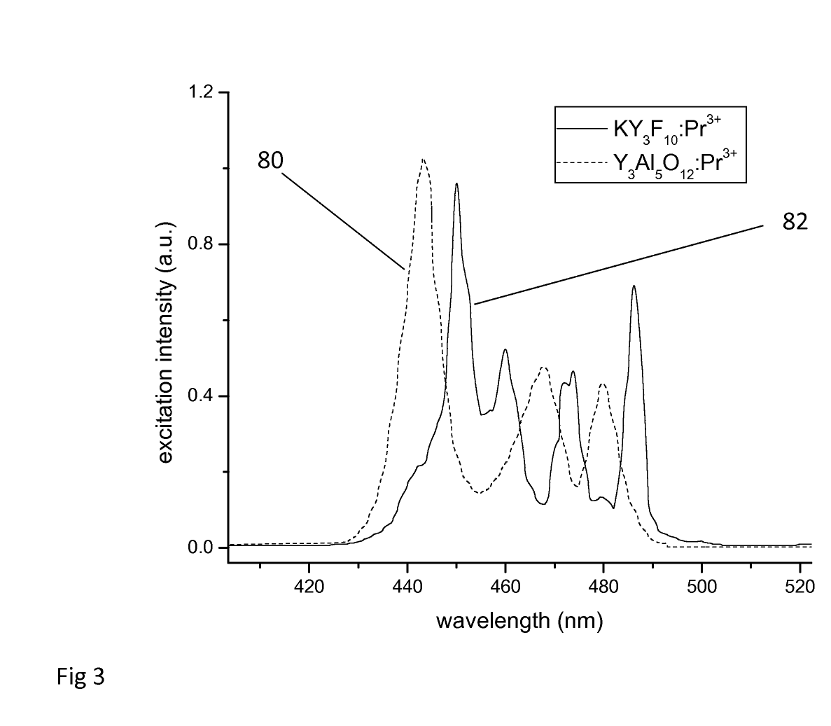

Referring now to FIG. 3 which shows typical excitation spectra of two emissive materials, Y₃Al₅O₁₂:Pr³⁺ 80 and KY₃F₁₀:Pr³⁺ 82. The Pr³⁺ ion is the emissive element in these materials. Because it is embedded in a different host matrix (Y₃Al₅O₁₂ in the first case and KY₃F₁₀ in the second case) the excitation spectra are shifted slightly. For example, the excitation maximum of Y₃Al₅O₁₂:Pr³⁺ is slightly longer in wavelength than 450. A semiconductor laser that emits light at a wavelength of 450 nm at room temperature (22° C.) is a suitable excitation source for these markers. If a temperature scan of the laser is conducted and the marker response is collected at various temperatures, it can be expected that the response profile of Y₃Al₅O₁₂:Pr³⁺ will be different from the response profile of KY₃F₁₀:Pr³⁺, thus enabling the security marker detection system to distinguish between the two markers.

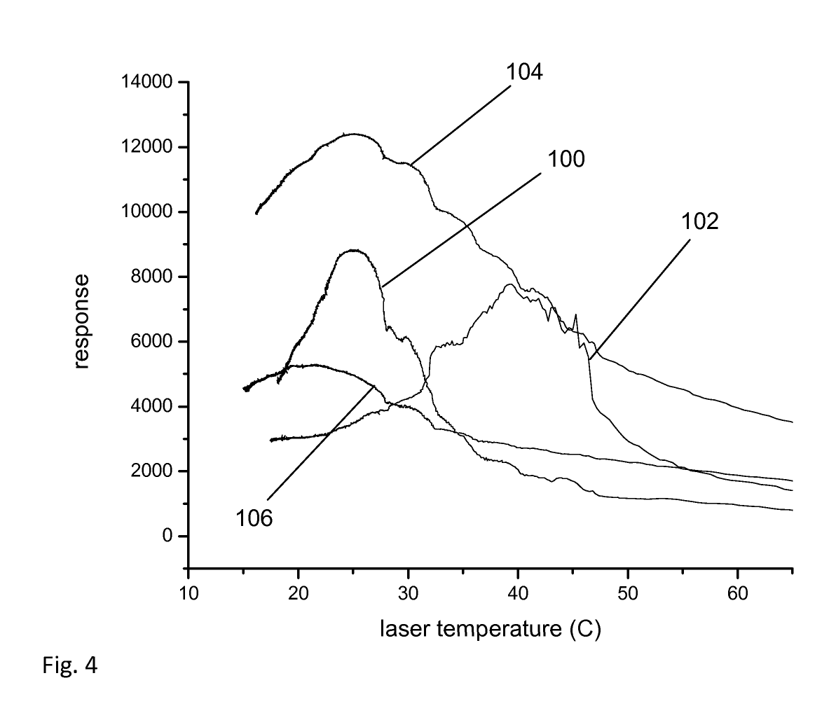

Referring now to FIG. 4 which shows a selection of measured marker response profiles using the security marker detection system. The response profiles were obtained during separate temperature scans.

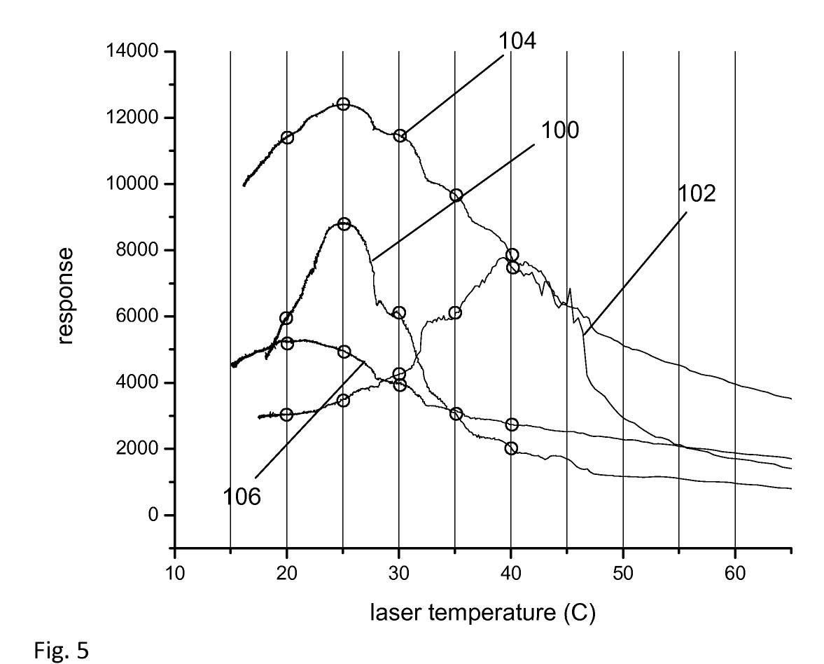

Referring now to FIG. 5 which shows an example of how discrete response values can be extracted from the measured profiles at equidistant temperature increments.

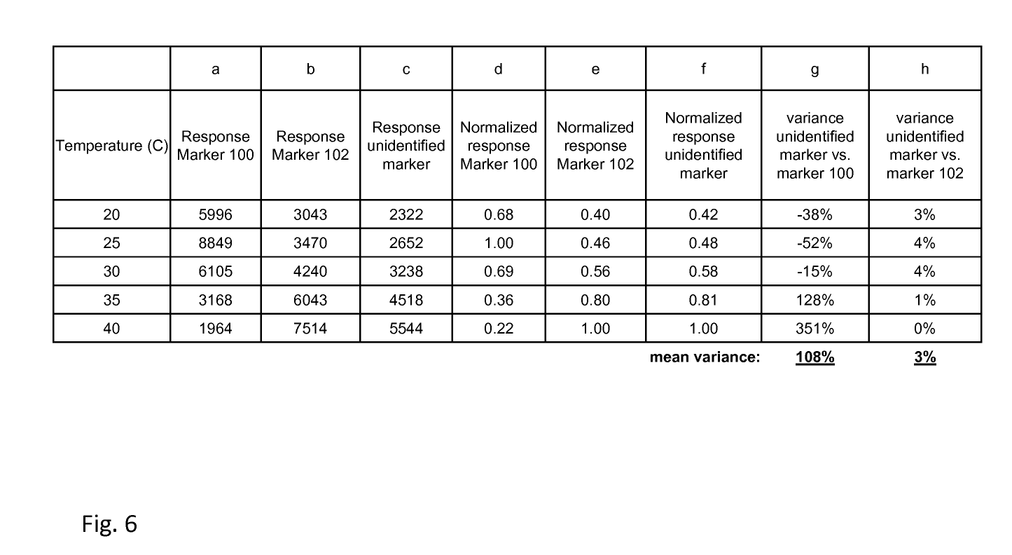

Referring now to FIG. 6 which shows a table of response values for marker 100, 102 and an unknown marker and columns a-c. The normalized response is shown in columns d-f. From the normalized response, variances of response are calculated for the unknown marker versus the markers 100 and 102 (columns g and h). The mean square variance given at the bottom of columns g and h is clearly lower for the pairing of unknown marker and marker 102 than for the pairing of unknown marker and marker 100. The security marker detection system can use this method to identify the unknown marker as marker 102 and base the pass/fail response on whether marker 102 was the intended/expected marker for the authentic item. It should be obvious for people skilled in the art that other methods exist to quantify similarities between response curves.

The emission wavelength of a semiconductor laser does not only vary with temperature, but also can be subject to manufacturing tolerances. This variability can be compensated, for example, by determining a temperature offset for a particular laser at a predetermined temperature that is correlated with the deviation of the emission wavelength this laser from a calibrated laser at the same temperature. This offset value is then used by the microcontroller to correct the measured temperature and replace it with a “wavelength adjusted” temperature.

The invention has been described in detail with particular reference to certain preferred embodiments thereof, but it will be understood that variations and modifications can be effected within the scope of the invention.

### PARTS LIST

10 security marker detection system
12 button to initiate authentication
14 authentication indicator pass
16 authentication indicator fail
18 marked item to be authenticated
20 security marker particle
22 irradiation source
24 exciting electromagnetic radiation
26 emitted electromagnetic radiation
28 temperature sensor
29 heating/cooling element
28 camera module
30 microprocessor
32 authentication indicator
39 authentication device employing non image-wise detection
40 photodetector
80 excitation spectrum of Y₃Al₅O₁₂:Pr³⁺
82 excitation spectrum of KY₃F₁₀:Pr³⁺
100 Marker A
102 Marker B
104 Marker C
106 Marker D

1. A method for authenticating security markers comprising:
illuminating the security marker with a laser or LED;
detecting an optical response from the security marker;
changing a temperature of the laser or LED to vary the wavelength of radiation produced by the laser or LED;
detecting changes in the optical response from the security marker as the wavelength of the radiation changes;
comparing the optical response profile from the security marker as it varies with changes in wavelength to a reference profile; and
authenticating the security marker if the optical response profile matches the reference profile.

2. The method of claim 1 comprising:
the temperature of the laser or LED is increased over a predetermined range.

3. The method of claim 1 comprising:
the temperature of the laser or LED is decreased over a predetermined range.

4. The method of claim 1 comprising:
the temperature of the laser or LED is decreased over a predetermined range; and
the temperature of the laser or LED is increased over a predetermined range.

5. The method of claim 1 wherein:
the laser or LED is in contact with a temperature sensor and a heating or cooling element or both.

6. The method of claim 1 wherein:
a temperature offset is determined based on the deviation of the wavelength of the laser or LED from the wavelength of a calibrated laser at a predetermined temperature and used as a calibration parameter.

7. The method of claim 1 wherein:
the security marker comprises at least one optically active element.

8. The method of claim 7 comprising:
the optically active element is selected from a group consisting of emissive or absorptive or combinations of both optically active elements.
